(19) United States
(12) Patent Application Publication
(10) Pub. No.: US 2019/0370839 A1
(43) Pub. Date: Dec. 5, 2019

(54) Multi-Modal Fungible Digital Bonds with Emergent and Demergent Properties

(71) Applicant: GAME COMPLEX, INC., AUSTIN, TX (US)

(72) Inventors: Brian Fahmie, La Jolla, CA (US); Thomas Athanas, Austin, TX (US)

(21) Appl. No.: 16/416,212

(22) Filed: May 18, 2019

Related U.S. Application Data
(60) Provisional application No. 62/678,254, filed on May 30, 2018.
(60) Provisional application No. 62/678,428, filed on May 31, 2018.

(51) Int. Cl. G06Q 30/02; G06Q 20/06; G07F 17/32

(52) U.S. Cl. CPC G06Q 30/0209; H04W 4/029; G07F 17/3244; G06Q 20/065

(57) ABSTRACT

A fungible digital bond featuring multiple modalities with properties that can emerge or demerge over time due to network effects, use of the bond within one or more interconnected or disconnected networks, conversions triggered by the issuer, government regulations, or other internal or external forces within the bond's ecosystem and touchpoints. Stand-alone and synthetic economies feature Multi-Modal Fungible Digital Bonds with Emergent and Demergent Properties facultatively as materially different from securitized and centralized banking that digital currency is being used to replaced, or similar.

### CROSS-REFERENCE TO RELATED APPLICATIONS

This application claims the benefit of, and priority to, U.S. Provisional Patent Application Ser. Nos. 62/678,254 filed May 30, 2018 and 62/678,428, filed May 31, 2018, the contents of which are incorporated herein by reference herein in its entirety.

### BRIEF DESCRIPTION OF THE DRAWINGS

Various preferred embodiments are described herein with references to the drawings in which merely illustrative views are offered for consideration, whereby:

FIG. 1 is a flowchart showing the steps for the Multi-Modal Fungible Digital Bonds with Emergent and Demergent Properties.

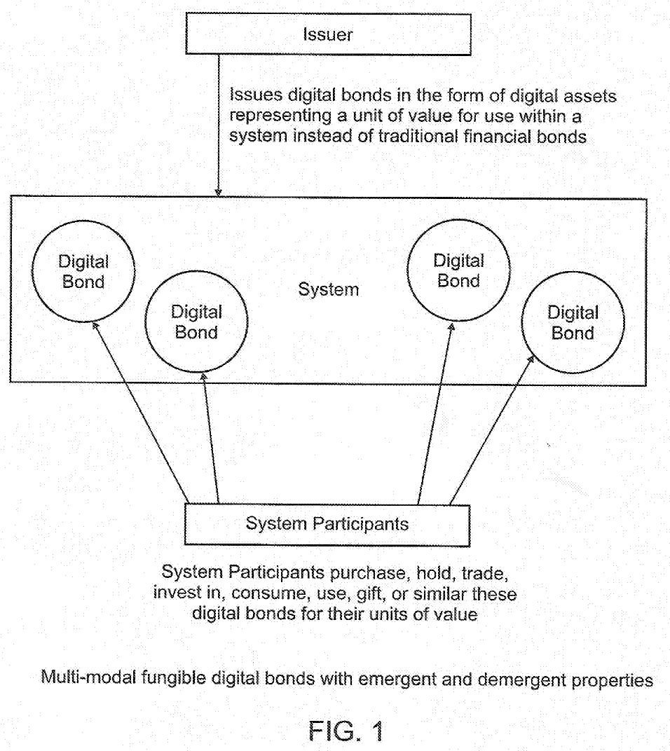

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements in the FIGURES may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTIONS

### Definitions

“INSERT COIN” as used herein in a generic place-holding capacity finds reference to any digital currency said currency being related to an Issuer of digital bonds in the form of digital assets representing a unit of value for use within a system instead of traditional financial bonds, and/or such derivative financial instruments based upon the same, as may otherwise be hypothecated in any medium, form, format or context.

Traditionally, fungible financial instruments fit neatly into a single category: securities, commodities, or currencies. Recently, with the advent of cryptocurrencies, these fungible digital assets can have characteristics of securities, commodities, and currencies simultaneously. This multi-modality of cryptocurrencies requires new fungible financial instrument frameworks to be devised in order for these cryptocurrencies to comply with laws and regulations from the multiple legal frameworks that govern traditional financial instruments given the overlapping characteristics of cryptocurrencies and similar digital assets.

The present invention generally describes systems and methods for structuring digital currencies, virtual currencies, or cryptocurrencies and their similar counterparts of digital coins, digital tokens, or digital assets as multi-modal fungible digital bonds with emergent and demergent properties. These bonds will have characteristics of securities, commodities, and currencies at points simultaneously, with emergent and demergent properties that can evolve over time.

At the most basic level, these digital bonds are digital assets within a system, network, blockchain, distributed ledger, protocol, economy, or similar construct that represent some sort of value within that system. For purposes of this disclosure, value is defined as a monetary value, network value, utility value, credit value, entertainment value, consumer value, consumptive value, intrinsic value within a system, or any other quantifiable type of value currently known or yet unknown.

At times these bonds may represent units of a traditional financial bond, with an issuer choosing to issue these fungible digital bonds with traditional bond mechanics and properties such as terms, coupon payments, interest rates, etc. imbued within these digital bonds, instead of a traditional bond offering in the traditional financial markets.

These bonds are generally issued by an issuer who exerts some level of control over the bonds and provides the initial collateral for the bond. However, these bonds could be emergent within a system, propagating from the system itself without direct issuance by an issuer.

An issuer may cease to exist, or cease exerting some level of control over the bonds, at some point in time post issuance. This can occur in such cases where the control of the digital bonds is relinquished by the issuer to be controlled by the system itself, or in a decentralized fashion by system participants independent of the issuer after the issuer relinquishes control over the bonds and their associated system.

At times, the system itself may provide some or all of the collateral for the bonds, either at issuance, through extension or growth of the system, or over time.

### Key Features:

Multi-modality of a fungible digital bond represented by a unit of digital currency, virtual currency, crypto currency, digital coin, digital token, or digital asset

Emergent and demergent properties over time (can be partial, all, or none of securities, commodities, and currencies simultaneously, and can change over time, i.e. its properties can always be in flux)

Self-collateralization by system value as collateral instead of collateral by issuer

Can convert to this over time, i.e. bond can become self-collateralizing with imbued or gained system value (or similar value) instead of collateral held by issuer.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language mans that a particular feature, structure, or characteristic described in connection with the embodiment is included in at least one embodiment of the present invention. Thus, appearances of the phrases “in one embodiment.” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core i5, Intel Core I & Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A system for gamification of real time physical reality immersive experiences, comprising, in combination:
at least a physical medium comprising multiple checkpoints at locations arrayed along a course, each checkpoint comprising a data capture spot to capture choices of multiple independent users traversing the course;
at least one unique identifying device for connecting to and monitoring the progress of at least one of the users;
a master control system operatively linked to the physical medium;
a versioning control system whereby the users may complete real time physical reality immersive experiences simultaneously;
wherein the master control system simultaneously manages, for the multiple independent users, challenge interactions with checkpoints and resultory scoring totals as the users traverse the course, while being interactively viewed by both multiple independent users and other observers of said system;
further comprising an operations team who design, program, manage, control, and update involved control systems;
wherein the versioning control system comprises versioning software and communication interfaces along with hardware implementing the same;
wherein the system is operable to produce multiple versions existing concurrently at locations which are remote relative to each other while being interactively viewed by both multiple independent users and other observers of said system;
wherein an issued currency, for example, denominated INSERT COIN is included;
said INSERT COIN currency being related to an Issuer of digital bonds in the form of digital assets representing a unit of value for use within a system instead of traditional financial bonds;
said INSERT COIN currency being related to an Issuer of digital bonds in the form of digital assets representing a unit of value for use within a system instead of traditional financial bonds; AND system participants purchase, hold, trade, invest in, consumer use, gift of similarly dispose of said digital bonds for their units of value.

2. A system for gamification of real time physical reality immersive experiences, according to claim 1, comprising, in combination:
at least a physical medium comprising multiple checkpoints at locations arrayed along a course, each checkpoint comprising a data capture spot to capture choices of multiple independent users traversing the course;
at least one unique identifying device for connecting to and monitoring the progress of at least one of the users;
a master control system operatively linked to the physical medium;
a versioning control system whereby the users may complete real time physical reality immersive experiences simultaneously;
wherein the master control system simultaneously manages, for the multiple independent users, challenge interactions with checkpoints and resultory scoring totals as the users traverse the course, while being interactively viewed by both multiple independent users and other observers of said system;
further comprising an operations team who design, program, manage, control, and update involved control systems;
wherein the versioning control system comprises versioning software and communication interfaces along with hardware implementing the same;
wherein the system is operable to produce multiple versions existing concurrently at locations which are remote relative to each other while being interactively viewed by both multiple independent users and other observers of said system;
wherein an issued currency denominated INSERT COIN is included;
said INSERT COIN currency being related to an Issuer of digital bonds in the form of digital assets representing a unit of value for use within a system instead of traditional financial bonds;
said INSERT COIN currency being related to an Issuer of digital bonds in the form of digital assets representing a unit of value for use within a system instead of traditional financial bonds; AND system participants purchase, hold, trade, invest in, consumer use, gift of similarly dispose of said digital bonds for their units of value;
whereby the resultory scoring totals include virtual currency and synthetic economies further comprising Multi-Modal Fungible Digital Bonds with Emergent and Demergent Properties.

3. A system for gamification of real time physical reality immersive experiences according to claim 2, including shared intellectual property assets incorporated by reference herein, with at least a physical medium comprising multiple checkpoints at locations arrayed along a course, each checkpoint comprising a data capture spot to capture choices of multiple independent users traversing the course according to each PCT specification incorporated herein by reference and the digital bonds defined by the FIGURE herein.

4. Multi-Modal Fungible Digital Bonds with Emergent and Demergent Properties further comprising a stand-alone platform materially different from securitized and centralized banking in that digital currency is being used to replace.

5. Multi-Modal Fungible Digital Bonds with Emergent and Demergent Properties according to claim 4, further comprising a stand-alone platform not materially different from securitized and centralized banking in that digital currency is being used to replace.

6. Novel digital currency comprising Multi-Modal Fungible Digital Bonds with Emergent and Demergent Properties.

7. A synthetic economy including Multi-Modal Fungible Digital Bonds with Emergent and Demergent Properties further comprising a bond-driven platform driven by AI and using said data to review, revise, supplement or repeat, based upon actions governed by human interventions within the process.
